(19) United States
(12) Patent Application Publication
(10) Pub. No.: US 2014/0097781 A1
(43) Pub. Date: Apr. 10, 2014

(54) CONTROL CIRCUIT FOR FAN

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: KANG WU, Shenzhen (CN); BO TIAN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/891,177

(22) Filed: May 9, 2013

(30) Foreign Application Priority Data
Oct. 10, 2012 (CN) 2012103817373

(51) Int. Cl. G05D 23/20

(52) U.S. Cl. CPC G05D 23/20
USPC 318/471

(57) ABSTRACT

A control circuit includes a temperature measuring module and a control module. The temperature measuring module includes a thermistor. The thermistor is arranged adjacent to an electronic element. The control module includes a monitoring chip and a register. The register stores a number of temperature values and duty cycle of a number of pulse width modulation (PWM) signals corresponding to the temperature values. The monitoring chip obtains temperature of the electronic element measured by the thermistor and outputs a PWM signal according to the measured temperature, to control a rotation speed of the fan.

### BACKGROUND

1. Technical Field

The present disclosure relates to a control circuit for a fan.

2. Description of Related Art

At present, a number of fans are arranged in a computer for dissipating heat for electronic elements of the computer. However, rotation speeds of the fans cannot be controlled automatically for saving power. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an embodiment of a control circuit for a fan.

FIG. 2 is a circuit diagram of the control circuit of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

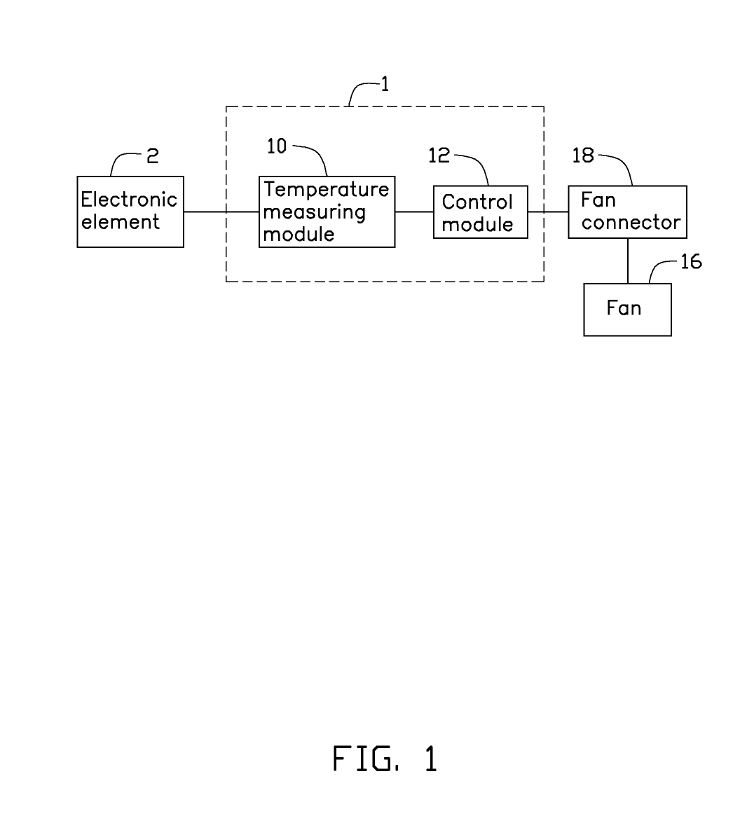

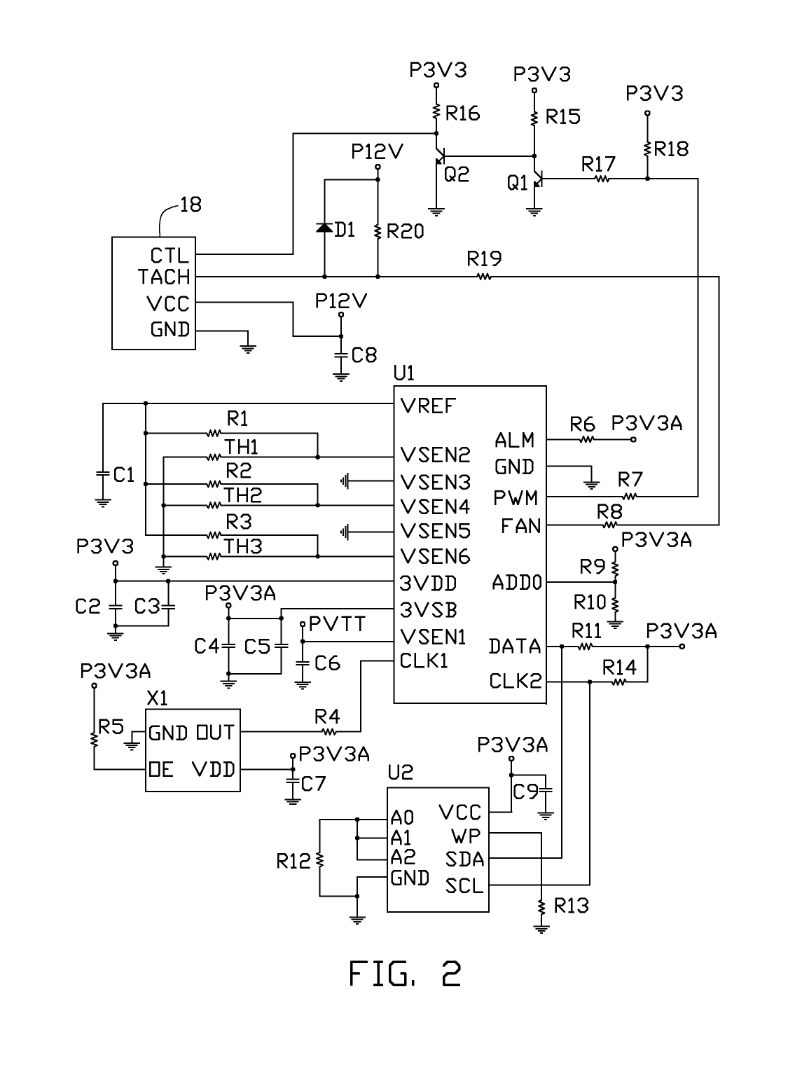

FIGS. 1 and 2 show an embodiment of a control circuit 1 for controlling a rotation speed of a fan 16 connected to a fan connector 18. The control circuit 1 includes a temperature measuring module 10 and a control module 12.

The temperature measuring module 10 includes thermistors TH1, TH2, and TH3. The thermistors TH1-TH3 are arranged adjacent to an electronic element 2. The temperature measuring module 10 measures the temperature of the electronic element 2 and the environment temperature around the electronic element 2.

The control module 12 includes a monitoring chip U1 and a register U2. The monitoring chip U1 is connected to the temperature measuring module 10, to receive a measured temperature from the temperature measuring module 10. The register U2 stores a rotation speed control table, which includes a plurality of temperature values and duty cycle of a plurality of pulse width modulation (PWM) signals corresponding to the temperature values. The monitoring chip U1 outputs a PWM signal according to the measured temperature and the rotation speed control table, for controlling the rotation speed of the fan 16. At the same time, the monitoring chip U1 receives a feedback rotation speed signal from the fan 16 when the fan 16 operates normally.

Voltage sensing pins VSEN2, VSEN4, and VSEN6 of the monitoring chip U1 are grounded through the thermistors TH1, TH2, and TH3, respectively. The voltage sensing pin VSEN2, VSEN4, and VSEN6 are also connected to a first end of a capacitor C1 through resistors R1, R2, and R3, respectively. A second end of the capacitor C1 is grounded. Voltage sensing pins VSEN3 and VSEN5 of the monitoring chip U1 are grounded. A ground pin VREF of the monitoring chip U1 is connected to the first end of the capacitor C1. A ground pin GND of the monitoring chip U1 is grounded. A voltage pin 3VDD of the monitoring chip U1 is connected to a power source P3V3 and also grounded through a capacitor C2. A capacitor C3 is connected to the capacitor C2 in parallel. A voltage pin 3VSB of the monitoring chip U1 is connected to a power source P3V3A and also grounded through a capacitor C4. A capacitor C5 is connected to the capacitor C4 in parallel.

A voltage sensing pin VSEN1 of the monitoring chip U1 is connected to a power source PVTT and also grounded through a capacitor C6. A clock pin CLK1 of the monitoring chip U1 is connected to an output pin OUT of a clock chip X1 through a resistor R4. A ground pin GND of the clock chip X1 is grounded. A voltage pin VDD of the clock chip X1 is connected to the power source P3V3A and also grounded through a capacitor C7. An enable pin OE of the clock chip X1 is connected to the power source P3V3A through a resistor R5.

An alarm pin ALM of the monitoring chip U1 is connected to the power source P3V3A through a resistor R6. A pulse signal pin PWM of the monitoring chip U1 is connected to a base of a transistor Q1 through resistors R7 and R17 in sequence. An emitter of the transistor Q1 is grounded. A node between the resistors R7 and R17 is connected to the power source P3V3 through a resistor R18. A collector of the transistor Q1 is connected to the power source P3V3 through a resistor R15 and is also connected to a base of a transistor Q2. An emitter of the transistor Q2 is grounded. A collector of the transistor Q2 is connected to the power source P3V3 through a resistor R16 and also connected to a control pin CTL of the fan connector 18. A fan pin FAN of the monitoring chip U1 is connected to a rotation speed pin TACH of the fan connector 18 through resistors R8 and R19 in sequence. The rotation speed pin TACH of the fan connector 18 is also connected to a power source P12V through a resistor R20. A cathode of the diode D1 is connected to the power source P12V. An anode of the diode D1 is connected to the rotation speed pin TACH of the fan connector 18. A voltage pin VCC of the fan connector 18 is connected to the power source P12V and also grounded through a capacitor C8. A ground pin GND of the fan connector 18 is grounded.

An address pin ADD0 of the monitoring pin U1 is connected to the power source P3V3A through a resistor R9 and also grounded through a resistor R10. A data pin DATA of the monitoring chip U1 is connected to a serial data pin SDA of the register U2 and also connected to the power source P3V3A through a resistor R11. A clock pin CLK2 of the monitoring chip U1 is connected to a serial clock pin SCL of the register U2 and is also connected to the power source P3V3A through a resistor R14. Data pins A0, A1, and A2 of the register U2 are connected together and then are grounded through a resistor R12. A ground pin GND of the register U2 is grounded. A voltage pin VCC of the register U2 is connected to the power source P3V3A and is also grounded through a capacitor C9. A control pin WP of the register U2 is grounded through a resistor R13.

In use, the thermistors TH1, TH2, and TH3 measure the environment temperature and the temperature of the electronic element 2. Resistances of the thermistors TH1, TH2, and TH3 are changed according to the measured temperature. The monitoring chip U1 obtains the measured temperature according to the changing resistances of the thermistors TH1-TH3 through the voltage sensing pins VSEN2, VSEN4, and VSEN6 and calculates duty cycle of a PWM signal corresponding to the measured temperature according to the rotation speed control table. The monitoring chip U1 outputs the PWM signal to the control pin CTL of the fan connector 18 for controlling the rotation speed of the fan 16 connected to the fan connector 18. In one embodiment, when the pulse signal pin PWM of the monitoring chip U1 outputs a high level signal, the transistor Q1 is turned on. The transistor Q2 is turned off. The control pin CTL of the fan connector 18 receives a high level signal. When the pulse signal pin PWM of the monitoring chip U1 outputs a low level signal, the transistor Q1 is turned off. When the transistor Q2 is turned on, the control pin CTL of the fan connector 18 receives a low level signal.

At the same time, the monitoring chip U1 receives a feedback rotation speed of the fan 16 through the rotation speed pin TACH of the fan connector 18 and the fan pin FAN of the monitoring chip U1 when the fan 16 operates normally.

The control circuit 1 can measure the temperature of the electronic element 2 and the environment temperature around the electronic element 2 through the thermistors TH1, TH2, and TH3, and outputs a PWM signal through the monitoring chip U1 according to the measured temperature for controlling the rotation speed of the fan 16.

The foregoing description of the embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A control circuit applicable to control a fan, the control circuit comprising:
a temperature measuring module comprising at least one thermistor, wherein the at least one thermistor is arranged adjacent to an electronic element; and
a control module connected to the temperature measuring module, and comprising a monitoring chip and a register, wherein the register stores a plurality of temperature values and duty cycle of a plurality of pulse width modulation (PWM) signals corresponding to the temperature values, the monitoring chip obtains temperature of the electronic element measured by the at least one thermistor, and outputs a PWM signal according to the measured temperature, to control a rotation speed of the fan.

2. The control circuit of claim 1, wherein the at least one thermistor comprises first to third thermistors.

3. The control circuit of claim 2, wherein first to third voltage sensing pins of the monitoring chip are grounded through the first to third thermistors, respectively, the first to third voltage sensing pins of the monitoring chip are also connected to a first end of a first capacitor through first to third resistors, respectively, a second end of the first capacitor is grounded, fourth and fifth voltage sensing pins of the monitoring chip are grounded, a first ground pin of the monitoring chip is connected to the first end of the first capacitor, a second ground pin of the monitoring chip is grounded, a first voltage pin of the monitoring chip is connected to a first power source and also grounded through a second capacitor, a third capacitor is connected to the second capacitor in parallel, a second voltage pin of the monitoring chip is connected to a second power source and also grounded through a fourth capacitor, a fifth capacitor is connected to the fourth capacitor in parallel, a sixth voltage sensing pin of the monitoring chip is connected to a third power source and also grounded through a sixth capacitor.

4. The control circuit of claim 3, wherein a clock pin of the monitoring chip is connected to an output pin of a clock chip through a fourth resistor, a ground pin of the clock chip is grounded, a voltage pin of the clock chip is connected to the second power source and also grounded through a seventh capacitor, an enable pin of the clock pin is connected to the second power source through a fifth resistor, an alarm pin of the monitoring chip is connected to the second power source through a sixth resistor.

5. The control circuit of claim 4, wherein a pulse signal pin of the monitoring chip is connected to a base of a first transistor through a seventh resistor, an emitter of the first transistor is grounded, a collector of the first transistor is connected to the first power source through an eighth resistor and also connected to a base of a second transistor, an emitter of the second transistor is grounded, a collector of the second transistor is connected to the first power source through a ninth resistor, the collector of the second transistor is also connected to a control pin of the fan connector, a fan pin of the monitoring chip is connected to a rotation speed pin of the fan connector through tenth and eleventh resistors in sequence, the rotation pin of the fan connector is also connected to a fourth power source through a twelfth resistor, a cathode of a diode is connected to the fourth power source, an anode of the diode is connected to the rotation speed pin of the fan connector, a voltage pin of the fan connector is connected to the fourth power source and also grounded through an eighth capacitor, a ground pin of the fan connector is grounded.

6. The control circuit of claim 5, wherein an address pin of the monitoring chip is connected to the second power source through a thirteenth resistor and also grounded through a fourteenth resistor, a data pin of the monitoring chip is connected to a serial data pin of the register and also connected to the second power source through a fifteenth resistor, first to third data pin of the register are connected together and then grounded through a sixteenth resistor, a ground pin of the register is grounded, a voltage pin of the register is connected to the second power source and also grounded through a ninth capacitor, a control pin of the register is grounded through a seventeenth resistor, a serial clock pin of the register is connected to a clock pin of the monitoring chip, the clock pin of the monitoring chip is also connected to the second power source through an eighteenth resistor.
